(19) United States
(12) Patent Application Publication
(10) Pub. No.: US 2023/0051172 A1
(43) Pub. Date: Feb. 16, 2023

(54) CLAD POROUS METAL SUBSTRATE FOR ELECTROCHEMICAL CELL

(71) Applicant: PRECISION COMBUSTION, INC., North Haven, CT (US)

(72) Inventors: Toshio Suzuki, Guilford, CT (US); Timothy LaBreche, Woodbridge, CT (US); Christian Junaedi, Cheshire, CT (US); Subir Roychoudhury, Madison, CT (US); Hongpeng He, Hamden, CT (US)

(21) Appl. No.: 17/889,992

(22) Filed: Aug. 17, 2022

Related U.S. Application Data
(63) Continuation-in-part of application No. PCT/US22/18893, filed on Mar. 4, 2022.
(60) Provisional application No. 63/160,187, filed on Mar. 12, 2021.

(51) Int. Cl. H01M 8/0245; H01M 8/0232; H01M 8/0236; H01M 8/0243; H01M 4/86; H01M 4/90; H01M 8/1253; H01M 8/1226

(52) U.S. Cl. CPC H01M 8/0245; H01M 8/0232; H01M 8/0236; H01M 8/0243; H01M 4/8652; H01M 4/9066; H01M 4/9025; H01M 8/1253; H01M 8/1226; H01M 2004/8684; H01M 2004/8689; H01M 2008/1293

(57) ABSTRACT

A clad porous metal substrate for use in a metal-supported electrochemical cell, wherein a metal support layer of defined porosity is clad on top and bottom sides with a layer containing a metal and/or a metal oxide. A metal-supported electrochemical half-cell and a metal-supported electrochemical cell are also described.

### CROSS-REFERENCE TO RELATED APPLICATIONS

This application is a continuation-in-part of International Patent Application PCT/US22/18893, filed Mar. 4, 2022, which claims benefit of U.S. Provisional Application 63/160,187, filed Mar. 12, 2021.

### GOVERNMENT RIGHTS

This invention was made with support from the U.S. government under Contract No. W911NF20C0060, sponsored by the Department of Defense. The U.S. Government has certain rights in this invention.

### FIELD OF THE INVENTION

This invention pertains to a metal substrate for use in a metal-supported electrochemical cell. This invention also pertains to the metal-supported electrochemical cell constructed therewith. All components described herein are useful in fabricating and operating an electrochemical cell, for example, a solid oxide fuel cell (SOFC), a solid oxide electrolysis cell (SOEC), or a solid oxide electrochemical sensor.

### BACKGROUND OF THE INVENTION

An electrochemical cell is comprised of three essential components disposed in a layered configuration: an oxygen electrode, an electrolyte, and a fuel electrode. More particularly, in a solid oxide fuel cell (SOFC) operating in forward power production mode, the oxygen electrode functions to reduce molecular oxygen with a source of electrons to form oxide ions. The electrolyte functions as a medium to transport the oxide ions from the oxygen electrode to the fuel electrode The fuel electrode functions to oxidize a fuel feed, such as hydrogen, carbon monoxide, or a mixture thereof, with the oxide ions so as to produce water and carbon dioxide, respectively, with concomitant production of electrons. Methane is another suitable fuel feed. The electrodes are connected via an external electrical circuit, such that the electrons produced at the fuel electrode traverse the external circuit to the oxygen electrode while being available to do electrical work. The voltage achieved from one electrochemical cell is typically small; therefore, a plurality of such cells are connected in series to form a stack of higher power output. When operating in electrolysis mode, the electrochemical process is reversed. Water and carbon dioxide are reduced with electrons at the fuel electrode to form hydrogen and carbon monoxide, respectively, with concomitant production of oxide ions. The oxide ions migrate through the electrolyte to the cathode where they are oxidized to form oxygen with release of elections, which traverse the external circuit for use at the fuel electrode.

In order to provide structural support and strength to an electrochemical cell, a porous substrate has been used to anchor either the fuel electrode, the electrolyte, or the oxygen electrode. Among various kinds of substrate materials, a porous metal has been shown to be a desirable substrate for improved cell performance. Powder metallurgy can be used to prepare the porous metal substrate with varying porosity and pore sizes. Metal substrates typically require significant porosity (>20 volume percent) and have pores in a size range larger than 10 μm. These pore sizes, however, are larger than the particle sizes of conventional fuel electrode and electrolyte materials, which are usually in a sub-micron range. Moreover, the pore sizes of conventional metal substrates are larger than the typical thickness of the individual fuel electrode and electrolyte layers.

The skilled person will appreciate that the porosity and pore size of the metal substrate play an important role in avoiding defects during cell manufacture and operation. Substrates having the required porosity level and pores larger than 10 μm are prone disadvantageously to cave-in of electrode and electrolyte layers. Moreover, the porosity and large pores may cause unacceptable shrinkage of the substrate during fabrication of the cell, leading to warpage, cracks and other defects that reduce cell performance. As a further disadvantage, large pores reduce contact area between the metal substrate and the anode, resulting in higher contact resistance. Diffusion of fuel cell constituents is another problem. As an illustrative example, under operating conditions chromium in a substrate comprising a ferritic alloy can diffuse into a nickel/yttria-stabilized zirconia (Ni-YSZ) fuel electrode forming an undesirable nickel-chromium alloy.

One challenge has been to maintain the pore sizes in the metal substrate in a range smaller than 10 μm, in order to ensure that the pore sizes are smaller than the typical thickness (5-20 μm) of conventional fuel electrode and electrolyte layers applied on top of the metal substrate. Metal substrates, however, with pores smaller than 10 μm are difficult to realize in practical terms of reliable fabrication.

One desirable criterion of a high-performance fuel cell is its ability to achieve a high specific power in units of watts per kilogram (W/kg), which desirably is greater than about 1,000 W/kg, more desirably greater than about 2,000 W/kg. This power output requires a fuel cell operable at a current density of greater than about 1 Amp per square centimeter (1 A/cm²) while maintaining an acceptably thin and lightweight cell substrate.

In view of the above, it would be desirable to discover an improved porous metal substrate for use in an electrochemical cell, such that the substrate provides structural integrity in addition to being thin and lightweight so as to optimize specific power output. It would be desirable if such a substrate were substantially flat and defect-free in a thickness of less than about 1.1 millimeter (1.1 mm), preferably, less than about 0.5 mm, and with planar dimensions of typically up to about 10 centimeters by 10 centimeters (10 cm×10 cm) or greater, depending upon its intended application. It would also be desirable for the porous metal substrate to resist electrode cave-in and diffusion of electrode and electrolyte materials into the substrate. To achieve these ends, it would be desirable to provide components that control shrinkage of layers so as to minimize warpage, mismatched layers, and defect formation.

### SUMMARY OF THE INVENTION

In one aspect, this invention provides for a clad porous metal substrate for use in a metal-supported electrochemical cell, comprising in a layered configuration:

(a) a first clad layer comprising at least one of micron to submicron sized grains of a first metal and submicron grains of a first metal oxide;

(b) a porous metal support configured as a layer having a porosity ranging from 20 volume percent to 50 volume percent; and

(c) a second clad layer comprising at least one of micron to submicron sized grains of a second metal and submicron grains of a second metal oxide.

In yet another aspect, this invention provides for a novel metal-supported electrochemical half-cell comprising in a sandwich configuration:

(a) a first cermet layer comprising submicron-sized grains of a first metal and submicron-sized grains of a first metal oxide;

(b) a porous metal support configured as a layer having a porosity ranging from 20 volume percent to 50 volume percent;

(c) a second cermet layer comprising submicron-sized grains of a second metal and submicron-sized grains of a second metal oxide;

(d) an electrode layer; and

(e) an electrolyte layer.

In yet another aspect, this invention provides for a novel metal-supported electrochemical cell comprising in a layered configuration:

(a) a first cermet layer comprising submicron-sized grains of a first metal and submicron-sized grains of a first metal oxide;

(b) a porous metal support configured as a layer having a porosity ranging from 20 volume percent to 50 volume percent;

(c) a second cermet layer comprising submicron-sized grains of a second metal and submicron-sized grains of a second metal oxide;

(d) a first electrode layer;

(e) an electrolyte layer; and

(f) a second electrode layer having a polarity opposite that of the first electrode layer.

The clad porous metal substrate of this invention finds utility in a metal-supported solid oxide fuel cell (MS-SOFC), a solid oxide electrolysis cell (SOEC), or a solid oxide electrochemical sensor. As one technical advantage, the clad substrate is configured as an essentially flat, layered composite with acceptable shrinkage; and therefore, is essentially free of warpage and other defects. As another technical advantage, the substrate is disposed in a thickness of less than about 1.1 millimeter (<1.1 mm), preferably, less than about 0.5 mm. Using the porous metal substrate of this invention to fabricate an electrochemical cell advantageously realizes metal-supported cells having well-matched and substantially flat and defect-free surfaces with planar dimensions of up to about 10 cm by 10 cm or greater. Minimizing cell thickness while maintaining a substantially flat surface essentially free of defects and warpage is important to permit lower cell weight and a higher cell specific power, desirably, greater than about 1,000 W/kg, and more desirably, greater than about 2,000 W/kg. Implementation of the novel clad MS-SOFC of this invention provides for high power density and fast-response, and provides for durable fuel cell generators for many applications including aerospace, defense and energy sector applications.

### BRIEF DESCRIPTION OF THE DRAWINGS

FIG. 1 illustrates an embodiment of the clad metal-supported electrochemical cell of this invention employing an embodiment of the porous metal substrate of this invention.

FIG. 2 illustrates another embodiment of the clad metal-supported electrochemical cell of this invention employing an embodiment of the porous metal substrate of this invention.

FIG. 3 presents a polarization curve (I-V and I-P plots) obtained from operating an embodiment of a clad metal-supported solid oxide fuel cell of this invention.

### DETAILED DESCRIPTION OF THE INVENTION

For the purposes of this invention, the term “grains” refers to crystallites or particles of varying and randomly distributed small sizes as noted herein.

As used herein, the word “layer” refers to a quasi-two-dimensional structure wherein dimensions of length and width are significantly larger than dimension of thickness. A layer can be considered a plane or sheet of one thickness of a first material that covers all or a portion of the surface of a second material. The term as used herein does not limit the layer to any particular shape; for example, the layer can be in the form of a square, rectangle, hexagon, circle, ellipse, or any other shape as dictated by design. Generally, all layers in the electrochemical cell have the same shape so that they can be matched, sealed, and secured on edges and corners.

Where a range is set forth, the word “about” is placed before the lower limit of the range. Unless otherwise noted, the word “about” is intended to modify both the lower and upper limits of the range allowing for an acceptable variance in both lower and upper limits.

As one advantage, the porous metal substrate of this invention is substantially flat allowing for a secure and tight-fitting application of an electrode layer thereupon. The term “flat” refers to a level surface characterized by lines or tracings substantially without peaks and valleys. An acceptable level of flatness can be determined by visual inspection of the layer without magnification or by visual inspection under an optical microscope of about 10 to 20 times magnification.

As another advantage, the porous metal substrate of this invention is substantially defect-free, which means that the layer does not contain an unacceptable number of cracks, holes and other imperfections in surface uniformity. Again, defects can be identified by visual inspection of the layer without magnification or by visual inspection under an optical microscope of about 10 to 100 times magnification.

Yet another advantage, the porous metal substrate of this invention is thin and light-weight; the substrate comprising the porous metal support having a clad layer bonded on both top and bottom surfaces thereof.

In one illustrative embodiment, this invention provides for a clad porous metal substrate for use in a metal-supported electrochemical cell, comprising in a layered configuration:

(a) a first clad layer comprising micron to submicron-sized grains of a first metal selected from the group consisting of nickel, iron, cobalt, chromium, copper, manganese, and mixtures thereof, and submicron-sized grains of a first metal oxide selected from the group consisting of oxides of cerium, lanthanum, chromium, strontium, titanium, and mixtures thereof;

(b) a porous metal support configured as a layer having a porosity ranging from about 20 volume percent to 50 volume percent; and

(c) a second clad layer comprising micron to submicron-sized grains of a second metal selected from the group consisting of nickel, iron, cobalt, chromium, copper, manganese, and mixtures thereof, and submicron-sized grains of a second metal oxide selected from the group consisting of oxides of zirconium, cerium, lanthanum, chromium, strontium, titanium, and mixtures thereof.

In another illustrative embodiment, the metal content in the first and the second clad layer can range from between 0 and 60% by weight. The micron to submicron-sized grains of the first and second metals of any one of the aforementioned embodiments each independently range in size from greater than about 0.1 micron (μm) to less than 20 micron (μm).

In yet another illustrative embodiment of any one of the aforementioned embodiments. The submicron-sized grains of the first and second metal oxides each independently range in size from greater than about 0.1 micron (μm) to less than 1.0 micron (μm).

In another illustrative embodiment of any one of the aforementioned illustrative embodiments, the cermet layers/clad layers each independently have a thickness ranging from about 1 micron (1 μm) to 30 microns (30 μm).

In another illustrative embodiment of any one of the foregoing embodiments, the first and second cermet layers/clad layers comprise, respectively, micron to submicron-sized grains of a first metal and micron to submicron-sized grains of a second metal, each independently selected from nickel, copper, or iron.

In another illustrative embodiment of any one of the aforementioned embodiments, the layer of porous metal support has a thickness less than about 1.1 millimeters (<1.1 mm), and typically between about 80 microns (80 μm) and 1,000 μm.

In another illustrative embodiment of any one of the aforementioned embodiments, the layer of porous metal support does not contain a metal oxide (ceramic).

In another illustrative embodiment of any one of the aforementioned embodiments, the layer of porous metal support comprises a ferritic alloy, preferably, a ferritic alloy containing chromium in an amount greater than about 15 weight percent.

In another illustrative embodiment of any one of the foregoing embodiments, the first and second cermet layers/clad layers comprise, respectively, a first and second metal oxide, each metal oxide independently selected from ceria or a divalent or trivalent cation doped ceria. In an alternative embodiment, the first and second cermet layers/clad layers comprise, respectively, a first and second metal oxide, each independently selected from lanthanum chromite or a divalent or trivalent cation doped lanthanum chromite. In another illustrative embodiment, the first and second cermet layers/clad layers comprise, respectively, a first and second metal oxide, each independently selected from strontium titanate or a divalent or trivalent cation doped strontium titanate. In another illustrative embodiment, the first and second cermet layers/clad layers comprise, respectively, a first and second metal oxide, each independently selected from yttrium-stabilized zirconia.

In one illustrative embodiment, this invention provides for a metal-supported electrochemical half-cell comprising in a layered configuration:

(a) a first cermet layer comprising submicron-sized grains of a first metal selected from the group consisting of nickel, iron, cobalt, chromium, copper, manganese, and mixtures thereof, and submicron-sized grains of a first metal oxide selected from the group consisting of oxides of zirconium, cerium, lanthanum, chromium, strontium, titanium, and mixtures thereof;

(b) a porous metal support configured as a layer a porosity ranging from about 20 volume percent to 50 volume percent;

(c) a second cermet layer comprising submicron-sized grains of a second metal selected from the group consisting of nickel, iron, cobalt, chromium, copper, manganese, and mixtures thereof, and submicron-sized grains of a second metal oxide selected from the group consisting of oxides of zirconium, cerium, lanthanum, chromium, strontium, titanium, and mixtures thereof;

(d) an electrode layer; and

(e) an electrolyte layer.

In yet another illustrative embodiment, this invention provides for a metal-supported electrochemical cell comprising in a layered configuration:

(a) a first cermet layer comprising submicron-sized grains of a first metal selected from the group consisting of nickel, iron, cobalt, chromium, copper, manganese, and mixtures thereof, and submicron-grains of a first metal oxide selected from the group consisting of oxides of zirconium, cerium, lanthanum, chromium, strontium, titanium, and mixtures thereof;

(b) a porous metal support configured as a layer having a porosity ranging from about 20 volume percent to 50 volume percent;

(c) a second cermet layer comprising submicron-sized grains of a second metal selected from the group consisting of nickel, iron, cobalt, chromium, copper, manganese, and mixtures thereof, and submicron-grains of a second metal oxide selected from the group consisting of oxides of zirconium, cerium, lanthanum, chromium, strontium, titanium, and mixtures thereof;

(b) a first electrode layer;

(c) an electrolyte layer; and

(d) a second electrode layer, the second electrode layer having a polarity opposite that of the first electrode layer.

In yet another example of any one of the foregoing embodiments of this invention, the aforementioned electrochemical cell comprises a metal-supported solid oxide fuel cell or a metal-supported solid oxide electrolysis cell, wherein the first electrode layer is a fuel electrode (anode) layer and the second electrode layer is an oxygen or air electrode (cathode) layer. In another example of any one of the foregoing embodiments of this invention, the fuel electrode layer has a thickness between about 3 microns and 20 microns. In another example of any one of the foregoing embodiments of this invention, the electrolyte layer has a thickness between about 1 micron and 20 microns. In yet another example of any one of the foregoing embodiments of this invention, the oxygen electrode layer has a thickness between about 10 microns and 30 microns.

In another illustrative embodiment of any one of the foregoing embodiments of this invention, the fuel electrode layer is a composite comprising nickel or nickel oxide and a metal oxide selected from the group consisting of the oxides of zirconium, yttrium, cerium, scandium, gadolinium, samarium, calcium, lanthanum, strontium, magnesium, gallium, barium, and mixtures thereof. In one preferred embodiment the fuel electrode layer comprises nickel oxide-yttria stabilized zirconia, NiO-YSZ.

In yet another embodiment of any of the foregoing embodiments of this invention, the electrolyte layer comprises a metal oxide selected from the group consisting of the oxides of zirconium, yttrium, cerium, scandium, gadolinium, samarium, lanthanum, strontium, magnesium, gallium, barium, calcium and mixtures thereof. In one preferred embodiment, the electrolyte layer comprises yttria-stabilized zirconia.

In yet another embodiment of any one of the foregoing embodiments of this invention, the oxygen electrode layer is selected from compositions of formula ABO₃, wherein A is selected from the group consisting of barium, strontium, lanthanum, samarium, praseodymium, and combinations thereof, and B is selected from the group consisting of iron, cobalt, nickel and manganese. In a preferred embodiment, the ABO₃ is lanthanum strontium cobalt ferrite (LaSrCoFeO₃).

In another illustrative example of any one of the embodiments of the electrochemical cell of this invention, an interlayer is disposed in between the electrolyte layer and the oxygen electrode layer, optionally further wherein the interlayer has a thickness between about 1 micron and 20 microns. The interlayer functions to retard reaction between the electrolyte and the oxygen electrode or cathode materials. Typically, the interlayer comprises one or more divalent or trivalent cation elements doped with one or more metals selected from Group IIA elements. In one embodiment, the divalent or trivalent cation elements are selected from lanthanum, samarium, yttrium, gadolinium, and combinations thereof. In one embodiment, the interlayer is comprised of a divalent or trivalent cation doped ceria.

The electrochemical cell of this invention can be better envisioned from a consideration of the Drawings. FIG. 1 depicts an embodiment 10 of the metal-supported electrochemical cell of this invention, which comprises in a layered configuration the following components: the first cermet layer/clad layer or simply first layer 1, the porous metal support 3, the second cermet layer/clad layer or simply second layer 5, the first electrode (e.g., fuel electrode or anode) 7, the electrolyte 9, and the second electrode (e.g., oxygen electrode or cathode) 11 having a polarity opposite that of the first electrode. In an exemplary embodiment, the cermet-clad porous metal substrate of this invention comprises the three-layer composite 13 including the first cermet layer 1, the porous metal support 3 and the second cermet layer 5. In an exemplary embodiment, the clad porous metal substrate of this invention comprises the three-layer composite 13 including the first clad layer 1, the porous metal support 3 and the second clad layer 5.

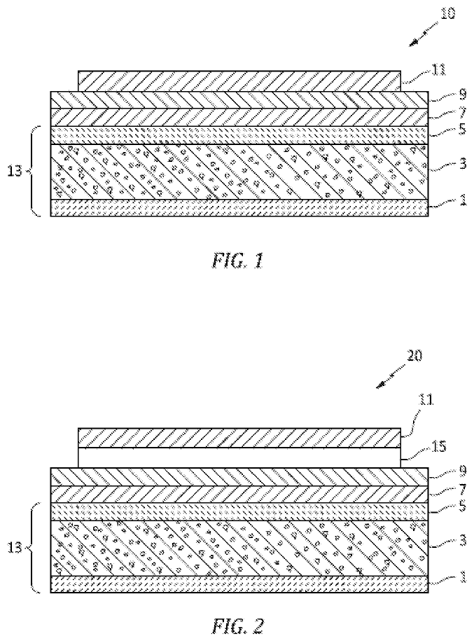

FIG. 2 depicts another embodiment 20 of the metal-supported electrochemical cell of this invention, which is similar in design to that illustrated in FIG. 1 excepting that an interlayer 15 is disposed in between the second electrode/cathode 11 and the electrolyte 9. This invention is not limited to the aforementioned layers. One skilled in the art will appreciate that other layers may be included in the electrochemical cell of this invention.

Generally, the porous metal support comprises any metallic material of suitable strength and conductivity for use in an electrochemical cell. The metal of the porous support can be provided as a pure metallic element or a combination of metallic elements as in an alloy. Non-limiting examples of suitable metal supports include ferritic alloys predominantly comprising iron and an amount of chromium over 15 weight percent, as well as smaller amounts of other metallic elements. The metal support is required to be “porous”, meaning that a plurality of pores, channels, and/or open cells are present throughout and within the support so as to facilitate diffusion of gaseous components there through. The porosity of the metal support is typically greater than about 20 volume percent. Desirably, the porosity of the metal support ranges from about 20 vol. percent to 50 vol. percent, based on the total volume of the metal support. Generally, pore size ranges from about 3 microns (3 μm) to 75 microns (75 μm). The porous metal support typically is formed into a thin sheet with a thickness ranging from about 80 microns (80 μm) to 1,000 microns (1 millimeter), preferably, from about 100 microns (0.1 millimeter) to 500 microns (0.5 millimeter).

Porous metal supports in the shape of a sheet or layer at the upper end of the thickness range (800-1,000 μm) are available from commercial suppliers. Below about 500 μm, the porous metal support can be fabricated by tape-casting from powders of the metal component(s). See, for example, US 2008/0096079, incorporated herein by reference, on the subject of preparing thin porous metal layers from metal powders. As well, see our description hereinafter.

The first and second metals provided as micro to submicron-sized grains in the respective first and second cermet layers/clad layers are generally obtained from metals providing for acceptable electrical conductivity. This is especially true for the second metal of the second cermet layer/clad layer upon which the first electrode layer is applied. In this instance, the second metal is selected to match or closely match the conductive metal in the electrode selected, so as to reduce resistance and facilitate electrical conductivity. In one embodiment, the first and second metals of the first and second cermet layers/clad layers are each independently selected from the group consisting of nickel iron, cobalt, chromium, copper, manganese, and mixtures thereof. Among these, nickel or copper is an advantageous embodiment. In an exemplary embodiment the metal content can range from about 0% to about 60%. In another exemplary embodiment the metal content can range from about 1% to about 55%. In an exemplary embodiment the first and second cermet/clad layers can include at least one of micron to submicron sized grains of a first metal and submicron grains of a first metal oxide. In an exemplary embodiment, the first and second cermet/clad layers can include submicron grains of a first metal oxide and remain electrically conductive.

The submicron-sized grains of the first and second metal oxides of the respective first and second cermet layers/clad layers are generally obtained from metal oxides providing for suitable porosity and oxide ion (O²) conductivity for use in an electrochemical cell. In one embodiment, the submicron-sized grains of the first and second metal oxides are each independently selected the group consisting of oxides of zirconium, cerium, lanthanum, chromium, strontium, titanium, and mixtures thereof. In one illustrative embodiment, the first and second metal oxides of the respective first cermet layer/clad layer and second cermet layer/clad layer (also known as “barrier layer”) are each ceria or a divalent or trivalent cation doped ceria, for example, gadolinium-doped ceria. In another illustrative embodiment, the first and second metal oxide are each yttria-stabilized zirconia. In another illustrative embodiment, the first and second metal oxides are each lanthanum chromite or a divalent or trivalent cation doped lanthanum chromite. In yet another illustrative embodiment, the first and second metal oxides are each strontium titanate or a divalent or trivalent cation doped strontium titanate. The layers function to fill-in gaps within the porous metal support and along the interface between the porous metal support and adjoining layers.

The clad porous metal substrate of this invention is prepared typically by tape-casting methods as well as ink printing as desired. The skilled person will appreciate that various embodiments are possible. In one illustrative embodiment, the substrate is prepared by individually tape-casting, in any convenient order, a green first layer, a green metal support layer, and a green second layer. The green metal support layer is tape-cast from metal powders and a pore former, as described hereinbelow. In a variation thereof, a green layer is tape-case and then cut into two pieces forming the first and second cermet layers/clad layers. Thereafter, the three tapes are stacked to form a sandwich in which the green support layer is disposed in between the green first and second cermet layers/clad layers. In another illustrative embodiment, a green first layer is tapecast. Next, a green metal support layer is tapecast on top of one side of the green first layer. Thereafter, a green second layer is tapecast on top of the green metal support layer. However, the tapes are cast, the resulting green three-layer composite is typically laminated by heating under pressure to seal the layers together and thereafter subjected to debinding and cosintering, resulting in the clad porous metal substrate.

To prepare the electrochemical half-cell of this invention, a first electrode ink, such as an anode ink, is printed on top of the second cermet layer; and an electrolyte ink is printed on top of the first electrode ink. The resulting green substrate-ink composite is fired in debinding and cosintering steps to arrive at the half-cell. The full electrochemical cell is realized by printing a second electrode ink, such as a cathode ink, on top of the electrolyte and firing again.

Tapecasting involves preparing a slurry (or “ink”) comprising a solvent, a binder, powdered forms of the desired metal components and ceramic components, as appropriate, and optionally, at least one of a plasticizer and dispersant. The thusly-prepared slurry is cast into a sheet or layer in a selected thickness. Accordingly, whereas the finished cermet/clad layer can incorporate first and second metals in elemental form, the slurries from which they are fabricated will contain metal precursor compounds that are transformed under the cosintering step into their respective elemental metals. The metal precursor compounds are typically corresponding metal oxides, but other metal compounds might also be suitable precursors to the first and second metals. As an example, if the first metal is nickel, a suitable precursor compound is nickel oxide.

Accordingly, the first cermet/clad ink comprises micron to submicron-sized powder particles of a first metal precursor and submicron-sized powder particles of the first metal oxide. The micron to submicron-sized particles of the first metal precursor and submicron-sized particles of first metal oxide range in size from greater than 0.1 micron (0.1 μm) to less than 20.0 micron (<20.0 μm) and from greater than 0.1 micron (0.1 μm) to less than 1 micron (<1 μm), respectively. The quantity of first metal or first metal precursor in the first cermet/clad ink ranges from about 0 to 60 wt. percent, based on the total weight of the first cermet/clad layer ink. The particles of the first metal oxide in the first cermet/clad layer ink ranges from about 40 to 100 wt. percent, based on the total weight of the first cermet/clad layer ink. The solvent employed in the first cermet/clad layer ink is selected typically from common organic solvents that are removable at a temperature between about 50° C. and 120° C. Such solvents are generally selected from the group consisting of alcohols, esters, and ketones and are typically supplied in an amount ranging from about 5 to 20 wt. percent, based on the total weight of the ink. The binder is selected from commercial binder formulations, for example, alcohol and polyvinyl-based binders in an amount ranging from about 5 to 20 wt. percent. Suitable plasticizers include those from phthalate and glycol groups, added typically in an amount ranging from about 1 to 10 wt. percent. Suitable dispersants include fish oil and amine groups provided in an amount ranging from about 1 to 10 wt. percent. After thorough mixing of all components, the resulting first cermet ink can be tape cast into a green first cermet/clad layer.

With respect to the porous metal support, the slurry comprises a solvent, a binder, a powdered form of the appropriate support metal, alloy or precursor thereto, a pore former, and optionally, at least one of a plasticizer and dispersant. The solvent, binder, plasticizer ad dispersant are selected as noted hereinabove. The pore former is employed in a in an amount and a particle size so as to provide for the pore volume and pore size desired. Suitable, non-limiting examples of pore formers for this invention include starch and polymethylmethacrylate (PMMA), used in an amount suitable to provide for a porosity typically ranging from about 20 vol. percent to 50 vol. percent. The support ink is tapecast into a green porous metal support layer or applied as a layer over the first cermet/clad layer.

The second cermet/clad layer ink is prepared in a manner similar to that described hereinabove for the first cermet/clad layer ink. The skilled person will realize that the first cermet/clad layer ink may be the same or different from the second cermet/clad layer ink.

In any case, a three-layer composite is assembled in which the green metal support layer is sandwiched in between the green first and second cermet/clad layers. Typically, the resulting green metal substrate composite is laminated by heating to a temperature up to about 100° C. at a pressure between about 100 psi and 1,000 psi. Thereafter, the resulting laminated composite is subjected to debinding and cosintering under conditions sufficient to obtain the clad porous metal substrate. The debinding step involves heating the laminated substrate under air at a temperature between about 60° C. and 700° C. The cosintering step involve heating the greenware substrate under a reducing mixture of hydrogen and an inert gas, such as helium, nitrogen or argon, while raising temperature to a range between about 900° C. and 1400° C., so as to sinter the layers and form the cermet-clad porous metal substrate.

The cermet/clad layers provide a technical advantage by reducing unacceptable shrinkage and warpage of the porous metal support and preventing cave-in of cell constituents into the pores of the metal support. As another technical advantage, the resulting layered substate is essentially flat without defects, which allows for excellent adherence of any electrode layer applied thereto. The porosity of the clad metal substrate allows for diffusion of gaseous components into and out of the support.

Materials useful for the first and second electrode materials are illustrated, for example, by fuel and oxygen electrodes. These should be stable at operating temperatures; should have a coefficient of thermal expansion compatible with that of the solid oxide electrolyte; and should be chemically compatible with the solid oxide electrolyte and other materials during fabrication and operation of the solid oxide cell. In power production mode, the function of the fuel electrode is to combine the oxide ions that diffuse through the electrolyte with the fuel supplied to the fuel electrode to produce water and carbon dioxide as well as to produce a flow of electrons.

The fuel electrode (or anode) is constructed of a porous layer allowing the fuel, typically a gaseous reformate comprising hydrogen and carbon monoxide, to diffuse inside the electrode. Since the fuel electrode must be electrically and ionically conductive, the fuel electrode comprises a combination of ceramic and metal, known as a cermet, prepared by standard ceramic processing techniques. Suitable fuel electrode layers comprise, for example, nickel or nickel oxide and a metal oxide selected from the group consisting of the oxides of zirconium, yttrium, cerium, scandium, gadolinium, samarium, calcium, lanthanum, strontium, magnesium, gallium, barium, and mixtures thereof. In one embodiment the fuel electrode layer comprises nickel oxide-yttria stabilized zirconia, NiO-YSZ.

The solid oxide electrolyte comprises a dense layer of ceramic that conducts oxide ions (O²⁻). Typically, the electrolyte comprises a metal oxide selected from the group consisting of scandium, cerium, zirconium, lanthanum, strontium, magnesium, gallium, barium, yttrium, gadolinium, samarium, calcium, and mixtures thereof. As an example of a material from which the solid oxide electrolyte layer can be made, we include yttria-stabilized zirconia (YSZ) and scandia-stabilized zirconia (ScSZ). As newer electrolytes are developed, these may lead to more robust materials and less resistivity problems by improving the conductivity of oxide ions, which in turn may lead to better performing electrolyte layers, any of which may be employed in this invention.

The second electrode, having a different polarity from the first electrode, comprises an oxygen electrode (or cathode) that is also porous so as to provide for a uniform flow of oxygen throughout. The oxygen electrode should also be capable of conducting oxide ions (O²) to the solid oxide electrolyte. As non-limiting examples of a material from which the oxygen electrode can be formed, lanthanum strontium manganite (LSM), lanthanum strontium ferrite (LSF), (La,Sr)(Co,Fe)O₃ and any of the cobalites are included.

The electrochemical half-cell of this invention is prepared by any suitable technique including applying layers by ink printing, tape-casting, lamination, and/or plasma spraying, following by one or more firing steps that include debinding, cosintering and cooling.

The fuel electrode, electrolyte, and oxygen electrode layers are fabricated starting from appropriate inks using screen printing and heating techniques. The ink typically contains a solvent, a binder, the specific metal(s) and ceramic(s) of the particular layer involved, and optionally, at least one of a binder and plasticizer. The solvent, binder, plasticizer and dispersant are suitably sourced from any of those mentioned hereinbefore. After thorough mixing, the fuel electrode ink is screen printed over the second cermet/clad layer (barrier layer). To fabricate the half-cell, a layer of electrolyte ink is screen printed over the first electrode ink. The resulting green half-cell composite is fired in a debinding and cosintering step. Debinding is typically conducted under air at a temperature between 60° C. and 700° C.; while co-sintering is conducted under a reducing atmosphere at a temperature up to 1,400° C. To complete the full cell, the second electrode layer is applied by screen printing a second electrode ink, e.g., cathode ink, over the electrolyte layer and repeating the debinding and cosintering steps.

Any individual electrochemical cell produces less than about 1 V under typical operating conditions, but most applications require higher voltages. Accordingly, for practical applications a plurality of individual electrochemical cells of this invention are connected in series to form a stack so as to obtain a higher voltage required for the application. The stack is constructed by securing each electrochemical cell between two interconnects that provide strength to the stack and separate the cells from each other.

Since the interconnects are exposed at high temperatures to both oxidizing and reducing sides of the cell, the interconnects should be stable under both circumstances. Accordingly, the interconnects are comprised of an electrically conductive material that is able to withstand the thermal and chemical environments to which they are exposed. In one embodiment, the interconnects are constructed of metallic plate or foil, for example, a high temperature stainless steel alloy. In another embodiment, the interconnects are constructed from metal oxide providing for acceptable thermal stability and electrical conductivity. This invention is not limited to any particular interconnect material or interconnect layer thickness.

### EXAMPLE

A clad porous metal substrate was constructed in accordance with this invention. A green cermet/clad layer (20 μm thickness) was tapecast from a first cermet/clad layer ink comprising solvent (alcohol), a polyvinyl binder (6 g), a phthalate plasticizer (1 g), a dispersant (fish oil, 1 g), submicron-sized particles of nickel oxide (30 g, 0.5 μm particle size) and submicron-sized particles of gadolinium-doped ceria (20 g, 0.1 μm particle size, 10% Gd). The green cermet/clad layer was cut into two pieces, providing the first and second green cermet/clad layers. Then, a green metal support layer was tapecast using a support ink comprising a powdered ferritic metal (FeCr alloy, 10 um average particle size, thickness of 0.2 mm) and a PMMA pore former (polymethylmethacrylate, 8 μm average particle size) mixed with solvent (alcohol), a polyvinyl binder (6 g), a phthalate plasticizer (1 g), a dispersant (fish oil, 1 g). The green support layer was sandwiched in between the green first and second cermet/clad layers; and the resulting green substrate composite was laminated by heating at 70° C. under 1,000 psi (6.9 MPa) pressure; after which the laminated composite was co-sintered at 1250° C. under a hydrogen-argon atmosphere to form the clad porous metal substrate of this invention. The metal clad substrate comprised a porous metal support having a porosity of 30 volume percent and an average pore size of 10 μm.

Next, a fuel electrode ink was screen-printed over the second cermet/clad layer. The fuel electrode ink (anode ink) comprised alcohol (6 g), polyvinyl binder (6 g), a phthalate plasticizer (1 g), a dispersant (fish oil, 1 g), nickel oxide (30 g), and yttria-stabilized zirconia (20 g). An electrolyte ink comprising alcohol (10 g), polyvinyl binder (6 g), phthalate plasticizer (2 g), fish oil dispersant (2 g), and scandium-stabilized zirconia (50 g) was screen-printed over the fuel electrode ink to form a green half-cell. The thusly-prepared green half-cell was debound under air up to a temperature of 600° C. and then co-sintered under a mixture of hydrogen (5 vol. percent) in inert gas to a temperature of 1,300° C., then cooling.

The co-sintered half-cell, evaluated with Scanning Electron Microscopy (SEM), indicated successful fabrication of an embodiment of the clad metal-supported solid oxide half-cell of this invention, with a clear boundary or interface between the layers of first cermet/clad layer, porous metal support, second cermet/clad (barrier) layer, fuel electrode (anode), and electrolyte. The half-cell was flat with essentially no warpage, shrinkage, or any other surface defects. Overall, the half-cell structure was acceptable for oxygen electrode deposition and fuel cell performance testing.

The aforementioned half-cell was used to fabricate a full clad metal-supported solid oxide fuel cell (MS-SOFC) which was tested for cell performance. The half-cell was coated over the electrolyte layer by screen printing with a green interlayer ink comprising doped ceria, then sintered. Then a green oxygen (cathode) electrode layer comprising LaSrCoFeO₃ was screen printed from ink over the interlayer. The resulting greenware was sintered to form the MS-SOFC (0.5 mm total thickness).

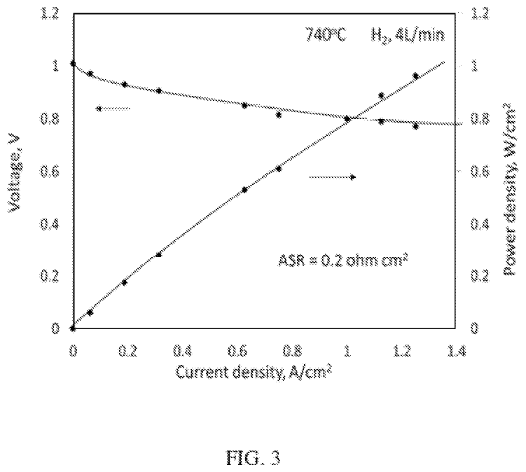

A 5×5 cm² (electrode area 4×4 cm²) cell fabricated according to this invention was tested using H₂ gas. The cell was set in a test furnace and temperature was increased to 900° C. for 1 h under anode (H₂) and cathode (air) gas flows. Then, the temperature was reduced to 740° C. for polarization and area specific resistance (ASR) tests. The results are shown in FIG. 3. As can be seen, 1.01 V of open cell voltage (OCV) was obtained and the cell performance was 0.78 W/cm² at a current density of 1 A/cm² (0.8V) and 0.96 W/cm² at 1.25 A/cm² (0.77V). Cell area specific resistance (ASR) was 0.2 ohm cm², indicating the potential for a maximum power density of greater than 1.25 W/cm².

When the cell was tested with a reformate as fuel feed comprising in mole percentages: hydrogen (26 percent), carbon monoxide (12 percent), carbon dioxide (9 percent), nitrogen (38 percent), steam (15 percent), the ASR was 0.17 Ohm cm².

The performance of the clad MS electrochemical cell of this invention is very good, correlating with several factors, namely, the flat structure enhanced by the cermet/clad layers, and the high porosity of metal support.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description but is only limited by the scope of the appended claims.

1. A clad porous metal substrate for use in a metal-supported electrochemical cell, comprising in a layered configuration:
(a) a first clad layer comprising at least one of micron to submicron sized grains of a first metal and submicron grains of a first metal oxide;
(b) a porous metal support configured as a layer having a porosity ranging from 20 volume percent to 50 volume percent;
(c) a second clad layer comprising at least one of micron to submicron sized grains of a second metal and submicron grains of a second metal oxide.

2. The clad porous metal substrate according to claim 1 wherein the porous metal support has a thickness ranging from 80 microns to 1,000 microns.

3. The clad porous metal substrate according to claim 1 wherein the porous metal support has pores ranging in size from 3 microns to 75 microns.

4. The clad porous metal substrate according to claim 1 wherein the porous metal support comprises a ferritic alloy, optionally comprising chromium in an amount greater than 15 mole percent.

5. The clad porous metal substrate according to claim 1 wherein the porous metal support does not contain a ceramic material.

6. The clad porous metal substrate according to claim 1 wherein the first and second layers each individually have a thickness ranging from 1 microns to 30 microns.

7. The clad porous metal substrate according to claim 1 wherein the micron to submicron-sized grains of the first metal and the second metal each independently range in size from greater than 0.1 micron to less than 20 microns; and the submicron-sized grains of the first metal oxides and second metal oxides each independently range in size from greater than 0.1 micron to less than 1.0 micron.

8. The clad porous metal substrate according to claim 1 wherein the metal content in the first clad layer and the second clad layer ranges between 0 and 60% by weight.

9. The clad porous metal substrate according to claim 1 wherein the first and second metals are each independently selected from the group consisting of nickel iron, cobalt, chromium, copper, manganese, and mixtures thereof.

10. The clad porous metal substrate according to claim 9 wherein the first and second metals are each independently selected from nickel or copper or iron.

11. The clad porous metal substrate according to claim 1 wherein the first and second metal oxides are each independently selected from the group consisting of oxides of zirconium, cerium, lanthanum, chromium, strontium, titanium, and divalent or trivalent cation-doped modifications thereof.

12. The clad porous metal substrate according to claim 1 wherein the first and second metal oxides comprise ceria or a divalent or trivalent cation-doped ceria; or wherein the first and second metal oxides comprise lanthanum chromite or a divalent or trivalent cation-doped lanthanum chromite; or wherein the first and second metal oxides comprise strontium titanate or a divalent or trivalent cation-doped strontium titanate.

13. The clad porous metal substrate according to claim 1 wherein the first clad layer and second clad layer each comprise nickel and gadolinium-doped ceria.

14. A metal-supported electrochemical half-cell comprising in a layered configuration:
(a) a first cermet layer comprising submicron-sized grains of a first metal and submicron-sized grains of a first metal oxide;
(b) a porous metal support configured as a layer having a porosity ranging from 20 volume percent to 50 volume percent;
(c) a second cermet layer comprising submicron-sized grains of a second metal and submicron-sized grains of a second metal oxide;
(d) an electrode layer; and
(e) an electrolyte layer.

15. A metal-supported electrochemical cell comprising in a layered configuration:
(a) a first cermet layer comprising submicron-sized grains of a first metal and submicron-sized grains of a first metal oxide;
(b) a porous metal support configured as a layer having a porosity ranging from 20 volume percent to 50 volume percent;
(c) a second cermet layer comprising submicron-sized grains of a second metal and submicron-sized grains of a second metal oxide;
(d) a first electrode layer;
(e) an electrolyte layer; and
(f) a second electrode layer having a polarity opposite to that of the first electrode layer.

16. The metal-supported electrochemical cell of claim 15 wherein the fuel electrode layer is a composite comprising nickel or nickel oxide and a metal oxide selected from the group consisting of the oxides of zirconium, yttrium, cerium, scandium, gadolinium, samarium, calcium, lanthanum, strontium, magnesium, gallium, barium, and mixtures thereof.

17. The metal-supported electrochemical cell of claim 15 wherein the electrolyte layer comprises a metal oxide selected from the group consisting of the oxides of zirconium, yttrium, cerium, scandium, gadolinium, samarium, lanthanum, strontium, magnesium, gallium, barium, calcium and mixtures thereof.

18. The metal-supported electrochemical cell of claim 15 wherein the oxygen electrode layer is selected from compositions of formula ABO₃, wherein A is selected from the group consisting of barium, strontium, lanthanum, samarium, praseodymium, and combinations thereof, and B is selected from the group consisting of iron, cobalt, nickel and manganese.

19. The metal-supported electrochemical cell of claim 15 wherein the first electrode layer is a fuel electrode (anode) layer and the second electrode layer is an oxygen or air electrode (cathode) layer.

20. The metal-supported solid oxide electrochemical cell of claim 15 wherein the fuel electrode layer has a thickness between 3 microns and 20 microns; the electrolyte layer has a thickness between 1 micron and 20 microns; and the oxygen electrode layer has a thickness between 10 microns and 30 microns.

21. The metal-supported electrochemical cell of claim 15 wherein an interlayer is disposed in between the electrolyte layer and the oxygen electrode layer.
